(19) United States
(12) Patent Application Publication
(10) Pub. No.: US 2004/0118265 A1
(43) Pub. Date: Jun. 24, 2004

(54) Flavored pick apparatus and method of manufacturing thereof

(76) Inventor: Ross Katz, Wheeling, IL (US)

Correspondence Address: Jeffrey A. Pine, BANIAK PINE & GANNON, Suite 1200, 150 N. Wacker Drive, Chicago, IL, 60606, US

(21) Appl. No.: 10/673,029

(22) Filed: Sep. 26, 2003

Related U.S. Application Data
(60) Provisional application No. 60/414,115, filed on Sep. 27, 2002.

(51) Int. Cl. G10D 3/16

(52) U.S. Cl. 84/322

(57) ABSTRACT

A pick or plectrum, used to play stringed instruments, containing a flavoring agent, which is imparted to a player of such instruments, when the pick is placed into the player's mouth. The flavoring agent can be located onto or in the pick during the manufacturing process or flavoring may be achieved by affixing a laminate containing a flavoring agent to a standard pick.

### FIELD OF THE INVENTION

The present invention relates to a novel pick or plectra apparatus, and methods for manufacturing thereof, which contain a flavor to be transferred to the mouth of the user of the pick. More particularly, the present invention relates to a novel pick, which contains a flavoring agent and is intended to be placed in the mouth of a player of stringed instruments, such as guitars and the like, thereby transferring some of the flavoring agent to the mouth of the player. Further, the present invention relates to a novel pick made of heat-sensitive materials that change colors based on changes in temperature. Additionally, the present invention relates to the methods of manufacturing such a flavored pick, and an apparatus to remove the moisture from the flavored pick after use. Further, the present invention also relates to an apparatus for storing and displaying one or more of the novel flavored picks.

### BACKGROUND OF THE INVENTION

Plectra or picks have long been used to assist the players of stringed instruments such as guitars, lutes, banjos and the like. These picks can be constructed from many different materials such as plastic, wood, metal, celluloid, bone, shell, flint glass, gold, or silver or from combinations of these materials. Typically, picks are manufactured from either wood or plastic and are flat and substantially triangle shaped; approximately two inches per side. However, various different sizes and shaped picks exist. In use, a pick is gripped between the thumb and forefinger and directed across the strings of a stringed instrument to make the sound.

Certain improvements in pick design have been directed at promoting improved musical performance. For example, U.S. Pat. No. 5,194,680, issued on Mar. 16, 1993 to Reineck, discloses a pick manufactured from a non-resilient, soft metal material, with special machining and coating, such that when used on metal-stringed instruments, ostensibly produces better articulation, improved harmonic attack and superior tones. U.S. Pat. No. 5,594,189, issued on Jan. 14, 1997 to Latteri, discloses a single assembly containing multiple picks, which, supposedly provides special sound by striking the same string more than once.

Other patents disclose improvements that have been directed to player convenience. U.S. Pat. No. 5,973,243 issued on Oct. 26, 1999 to Christenson describes a pick, attached or tethered to a ring type device worn on a finger, which supposedly facilitates rapid switching between conventional picking and bare fingering. U.S. Pat. No. 5,271,308 issued on Dec. 21, 1993 to Balog discloses a pick, which when inserted into and adhered to a pick shaped felt pocket, presumably provides an easier grip when player's fingers become sweaty, as well as presumably providing better pitch and different tones. U.S. Pat. No. 6,215,052 issued on Apr. 10, 2001 to Giddens, et al. discloses a multi-pick holder, mounted to an instrument strap of a player's belt, apparently providing rapid access to many picks and thus allowing convenient pick switching during a playing session.

When using a pick to play a musical stringed instrument, many players have a habit of putting the pick in their mouth, when not using it to pick the strings of their instrument. It would be of great enjoyment if a pick contained a flavor or flavoring agent, such that the player would receive that flavor when the pick was placed in the mouth. None of the prior art has disclosed the use of a novel flavored pick to take advantage of this habit. Further, none of the prior art discloses the use of heat-sensitive materials during the manufacture of a pick, such that the pick will change colors depending on a change in temperature. Additionally, none of the prior art has disclosed a device or procedure for addressing the problem of removing moisture from picks, which have become wet due to placing the pick in the player's mouth. Also, none of the prior art addresses the problem of displaying an assortment of flavored picks. The present invention addresses the foregoing and other shortcomings of the prior art.

### SUMMARY OF THE INVENTION

The present invention is a pick or plectra containing flavor or a flavoring agent such that the user of the pick will receive the flavor when the pick is placed into the player's mouth, thereby creating an enjoyable experience for the player.

It is the principal objective of the present invention to provide a plectra or pick containing a flavoring agent which a player of a stringed instrument may place in the player's mouth in order to receive the flavoring agent when the player is not using the pick to play the instrument.

It is an objective of the present invention to provide a pick which is manufactured using heat-sensitive materials, such that the pick will change colors if it is subjected to a temperature change. Such a change in temperature may be due to the holding of the pick or the placing of the pick in one's mouth.

It is an objective of the present invention to provide a pick which is covered, in whole or in part, molded with, printed on, casted, soaked, infused, etc. with a flavoring agent to provide the flavored pick. Flavoring agents can include, but are not limited to, spices, fruit flavors, etc. As understood by one having ordinary skill in the art, almost any flavor that exists can be replicated, and as such, can be used to flavor the pick of the present invention.

Many ways to manufacture such a flavored pick exist. One form of flavored pick is casted or molded from a solution containing a mixture of a suitable moldable material and a liquid form or particulate form of a desirable flavoring agent. Examples of some suitable molding materials include plastic, plastic polymer, wood, nylon, rubber, silicone and the like. Further, the flavoring agent is unlimited, i.e., mint, fruit flavored, spice flavored or candy flavored. Any flavoring agent can be used resulting in flavored picks, which allow the player to choose alternate flavors to suit player's mood or player's taste desire.

Additionally, this casted or molded form of flavored pick may be produced in various colors. One way to achieve these different colors is to add a food-grade coloring agent to the above-described solution prior to molding. Changing the coloring agent changes the color of the finished pick. The coloring of the pick can be used to identify the flavor. For example, a mint flavor might be color-coded blue, while a hot pepper taste could be color-coded bright red.

Another form of flavored pick is constructed by using an existing unflavored pick, similar to picks as currently manufactured, and adding a flavor or flavoring agent thereto. Picks can be made, entirely or in part, from materials such as wood, metal, celluloid, bone, shell, flint glass, gold, or silver and the like, and are widely available in the commercial marketplace and are frequently manufactured by such techniques as molding, stamping, carving, whittling, baking and machining. Using a standard pick, a flavoring agent is coated directly onto the pick by appropriate manufacturing steps, such as bonding, heating, soaking, pressuring, pasting, adhering, or the like, so as to convert the unflavored pick into a flavored pick.

Another process to create a flavored pick is to adhere a laminate containing the flavor or flavoring agent to the surface of an unflavored pick. The laminate may cover the entire pick on both sides, or may cover only a portion of one side, or something in between.

It is an additional objective of the present invention to provide a manufacturing method which makes a flavored pick by molding or casting a solution including two fluids or slurries; a liquid or slurry form of a suitable molding material such as plastic, and a liquid, slurry or particulate form of a desired flavoring agent.

It is an additional objective of the present invention to provide a manufacturing method that can produce flavored picks in a variety of flavors.

It is an additional objective of the present invention to provide a manufacturing method that mixes the flavoring agent with an edible or food-grade coloring agent resulting in an assortment of colored flavored picks. In this way, a scheme of color-coded flavored picks can be provided.

It is an additional object of the present invention to provide a manufacturing method whereby the flavoring agent is mixed with an edible ink and then printed, sprayed or screened onto the surface of a standard pick, thereby creating rather tasty logos or icons on the surface of the pick. The flavored printing not only carries the flavor into the player's mouth, but, in addition, the printed logos or icons, themselves, can represent certain flavors. For example, a picture of a lake can suggest mint flavor or a picture of a volcano might suggest spice flavor.

It is an additional objective of the present invention to provide a manufacturing method which makes a flavored pick by joining varying forms of flavoring agents to the surface of a standard pick, such joining comprising steps such as bonding, heating, soaking, pressuring, pasting, adhering, or the like so as to convert the unflavored pick into a flavored pick.

It is an additional object of the present invention to provide a manufacturing method wherein the flavoring agent is soaked, printed, screened, baked, pressed or vaporized onto a suitable carrier which carrier is then adhered to the surface of a standard pick thereby converting the standard pick into a flavored pick.

It is an additional objective of the present invention to provide a manufacturing method which makes a flavored pick by joining a suitable laminate, or other form of carrier, to the surface of a standard pick, such laminate or carrier having been previously infused with a desirable flavoring agent.

It is another object of the present invention to provide a manufacturing method which joins a laminate containing a flavoring agent to a standard pick by an appropriate manufacturing step, such as bonding, heating, pressuring, pasting, or adhering, and the like, so as to convert the unflavored pick into a flavored pick. By way of example, said laminate can be a porous material soaked in a fluid flavoring agent. Said laminate can be cut or shaped so as to free the edges of the pick for playing and holding.

Once a player has placed the flavored pick into the mouth, the pick will likely be wet. It is an additional objective of this invention to provide a device which removes moisture from any pick that the player has previously placed into the player's mouth. The present invention also removes moisture from any pick that the player has previously used to play and which has become wet from sweaty hands.

During a performance, a player, because of a personal desire for a particular flavor or pick, may want to change the pick presently in the player's mouth. It is an additional objective of the present invention to provide an apparatus which removes moisture from one or more flavored picks and also stores the same picks so that an assortment of differently flavored picks is available from which player may choose one or more picks for mouthing or for playing.

It is an additional objective of the present invention to provide a display apparatus for storing and displaying at least one, and usually an assortment of, flavored picks. The display case or stand provides for the identification or display of the flavored picks for collectors and the like.

### BRIEF DESCRIPTION OF THE DRAWINGS

Preferred embodiments of the invention are explained below with references to the accompanying drawings in which:

FIG. 1A is a front view of the preferred embodiment of a flavored pick according to the present invention;

FIG. 1B is a side view of the preferred embodiment of a flavored pick according to the present invention;

FIG. 1C is a cross-sectional view of FIG. 1A of the preferred embodiment of a flavored pick according to the present invention;

FIGS. 2A, 2B, 2C and 2D are representative cross-sectional views of alternate embodiments of the present invention resulting from the use of printing, coating and pressing methods to manufacture the flavored pick;

FIG. 3A is a cross-sectional view of an alternate embodiment of the present invention resulting from using a laminate as an alternate method to manufacture the flavored pick;

FIG. 3B is a top view of FIG. 3A of an alternate embodiment of the present invention;

FIG. 4A is a perspective view of a device for removing moisture from a wet pick according to the present invention;

FIG. 4B is cross-sectional view of 4A of a device for removing moisture from a wet pick according to the present invention;

FIG. 5A is a perspective view of a device for storing and displaying an assortment of flavored picks according to the present invention; and

FIG. 5B shows a clear cover for the device of FIG. 5A.

### DETAILED DESCRIPTION OF PREFERRED EMBODIMENTS

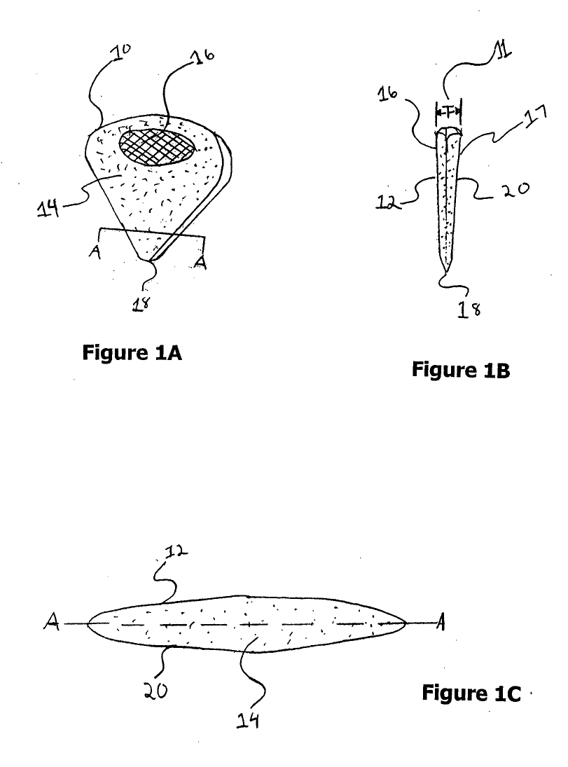

A flavored plectra, or pick, according to the present invention, is used to transfer flavor to the mouth of a player of a stringed instrument. FIGS. 1A, 1B and 1C illustrate, respectively, a front perspective view, a side view and a cross-sectional view (A-A from FIG. 1A), of the preferred embodiment of flavored pick 10. FIG. 1A shows a flavored pick 10 in accordance with the present invention. The pick 10 is similar in size and width to a standard pick. However, picks can be manufactured in different size and shapes as understood by one having ordinary skill in the art. The present invention is not limited to a particular size or shape, but will, for ease of understanding, be referred to below as the size and shape of a standard pick. Pick 10 contains a flavor or flavoring agent 14, which will be described in detail below. The flavor 14 can be infused into, laminated onto, printed, painted or otherwise applied to a standard pick to create the flavored pick 10. Further, the flavor 14 can be added during the casting or molding process to create a flavored pick 10. Also, the flavor can completely cover the flavored pick 10 or be placed on strategic or limited portions of the pick 10. The portions of the pick can include specific locations that are flavored (while other locations are not flavored) or just on the surface, or substantially on the surface (i.e., some of the flavoring agent below the surface), or any of the above combinations. The important aspect of the invention is that regardless of whether the flavoring agent is on top of or within the pick, or just on or just below the surface of the pick, when the player puts the pick into his or her mouth, the flavoring agent is detected.

Referring to FIG. 1B, pick 10 consists of two nearly co-planar triangular shaped sides 12 and 20. Sides 12 and 20 are formed in the shape of a wedge, the thickness of the top 11 of said wedge may vary between 0.3 mm. (usually considered by players to be a “thin” pick) and 1.5 mm. (usually considered by players to be a “thick” pick) and the bottom of said wedge thinning down essentially to a slightly beveled and rounded apex 18. In each of the described views, flavoring agent 14 is distributed evenly throughout the body of flavored pick 10. However, as described herein, an even distribution of the flavoring agent 14 is not necessary in the present invention.

When a player uses pick 10 to play a stringed instrument, the player typically grips the pick 10 by placing player's thumb at front area 16 and placing player's forefinger at rear area 17. The grip area 16, 17 can be the same material as the rest of the pick, or it can be etched, engraved, embossed or debossed to create a different feel than the rest of the pick. In this holding manner, the player strokes apex 18 across the strings of the played string instrument (not shown). When not in use, the pick 10 may be placed in the player's mouth. The player then receives the flavor 14.

The preferred method of manufacture of the present invention is molding. Flavored pick 10, shown front perspective view in FIG. 1A, is molded from a plastic or a plastic-like material which has been mixed, prior to molding, with a liquid or granular form of flavoring agent 14. After molding, the cross-section illustrated by FIG. 1C, shows that flavoring agent 14 is distributed evenly throughout the body of flavored pick 10.

Pick 10 can be molded using many different materials, such as a polyvinyl elastomer, thermoplastic elastomer, a natural rubber, silicone compounds, metal, such as gold or silver, acetal, delrin, nylon, acrylics, ultem, polyester, or any other plastic polymer and/or blends thereof, or the like as described herein, and, additionally, different molding processes, such as pour molding, injection molding or the like might be used.

Molding, the preferred manufacturing method of the present invention, as described above, creates a flavored pick wherein the flavoring agent 14 is distributed uniformly throughout the manufactured pick 10. Other distributions of flavoring agent 14, especially those concentrating the flavoring on the outer surface of the pick, are equally effective in transferring flavor to the player's mouth. Alternate preferred embodiments of such flavored picks are described below wherein the distribution of flavoring is concentrated on or at the top or bottom sides. Additionally, alternate embodiments of preferred manufacturing methods are described below by which such alternate embodiment flavored picks are manufactured.

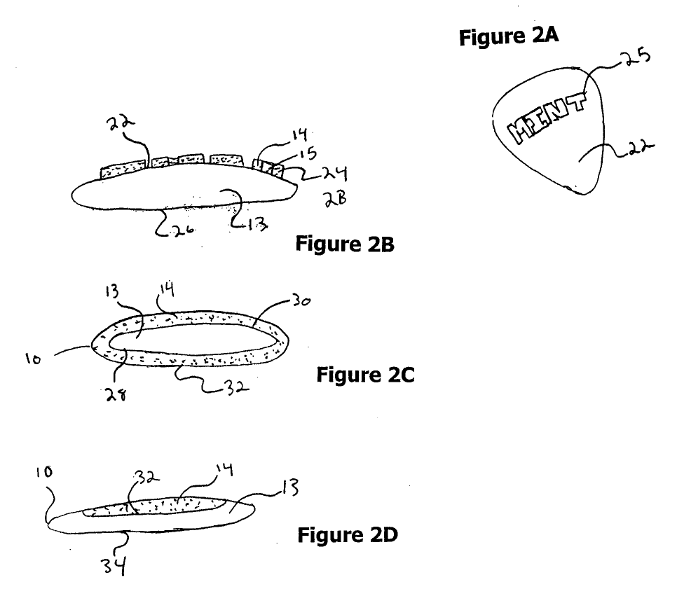

In an alternative embodiment, the flavoring of the pick 10 is accomplished by adding a flavoring agent to a standard pick, which is manufactured in accordance with current standards. Referring to FIG. 2B, a standard pick 13 may be made of plastic, plastic polymers, metal, bone, celluloid, gold, silver, rubber, glass, silicone or any like material as described herein. Additionally, the alternative embodiment described below is the approximate size and shape as that shown in FIGS. 1A and 1B.

An alternative embodiment of the present invention is shown in top view 2A and cross-section in FIG. 2B. The flavored pick 22 of this embodiment is an assembly containing a standard pick 13 and the pattern 25. Pattern 25 contains flavoring agent 14. Pattern 25 may take the form of characters and/or words, pictures, icons, logos and the like, however, pattern 25 may not be of a particular design. Pattern 25 can consist of specific words, such as “sweet” or “hot,” or similar nouns or adjectives to describe which flavor has been printed (or otherwise manufactured) onto the flavored pick 22. Pattern 25 may also consist of pictures representing individual flavors or flavor groups.

An alternative embodiment includes a pick, manufactured by any of the methods described herein, in which a heat-sensitive material is utilized. The heat-sensitive material provides a change of color to the pick when the pick is subjected to different temperatures. For example, when the pick is at room temperature, it may be blue; when it is held in the user's hand, it may be orange; and if placed in the user's mouth, it may turn red. These heat-sensitive materials can be added to a pick in many ways, including using a blended polymer product designed to provide these attributes, as understood by one having ordinary skill in the art.

A cross-section of another alternative embodiment of a flavored pick is shown in FIG. 2C. a standard pick 13 is coated with a hardened layer of an edible or food-grade, flavored compound 32. The flavored compound 32 may be formed such that selected areas of the pick 13 remain uncoated.

FIG. 2C also illustrates another alternative manufacturing method of the present invention in which a standard pick 13 is converted into a flavored pick 10. The standard pick 13, soon after it is molded and preferably while still warm (or if subsequently heated), is soaked in a solution of flavoring agent 14 which then bonds to, or infuses into, the pick 28, 30 (either on both sides, or throughout the entire pick), and then is dried. Alternatively, the standard pick 13 is soaked in a flavoring agent, which then bonds to the surfaces of the pick 28, 30 by a process such as heating or is baked into the pick resulting in a flavored pick 10. The resulting pick 10 will contain a flavor at the surface 32. Alternatively, flavoring agent 14 of FIG. 2C may be vaporized or painted onto one or both surfaces of the standard pick 13 before the above-described bonding process occurs. When desired, sections of the surfaces 28, 30 of the pick, such as the apex 18 described above in FIG. 1A, may be masked prior to application of flavoring agent 14 resulting in areas of the flavored pick 10 which remain free of flavoring 14.

A cross-section of another alternative embodiment of the present invention is shown in FIG. 2D. A standard pick 13 contains particles of flavoring agent 14 infused into surfaces 32, 34 (either one or both surfaces). The infused areas may be flush with the surface 34 or they may be raised so as to form a pattern as in FIG. 2A. Flavored pick 10 can be manufactured by pressing granules of flavoring agent 14 into surface 32 and/or into surface 34 of the standard pick 13 by mechanical means or by use of a high pressure chamber.

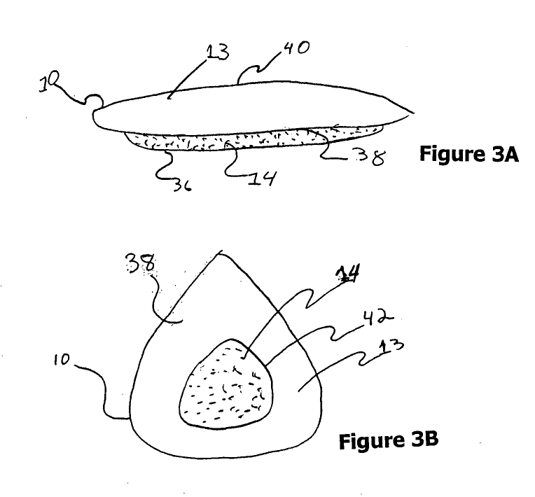

A cross-section of another alternative embodiment of the present invention is shown in FIGS. 3A and 3B. A laminate 36 containing flavoring agent 14 is adhered to surface 38 and/or surface 40 of standard pick 13. The laminate 36 may be trimmed as in FIG. 3B or shaped into the form of pattern 25 of FIG. 2A.

The laminate material 36, having been impregnated with a liquid, gaseous or granular flavoring agent 14, is then adhered to one or both surfaces 38, 40 of the pick 13 to form flavored pick 10. The laminate 36 may be trimmed into any desired shape or pattern 42 prior to adhering to the pick 10.

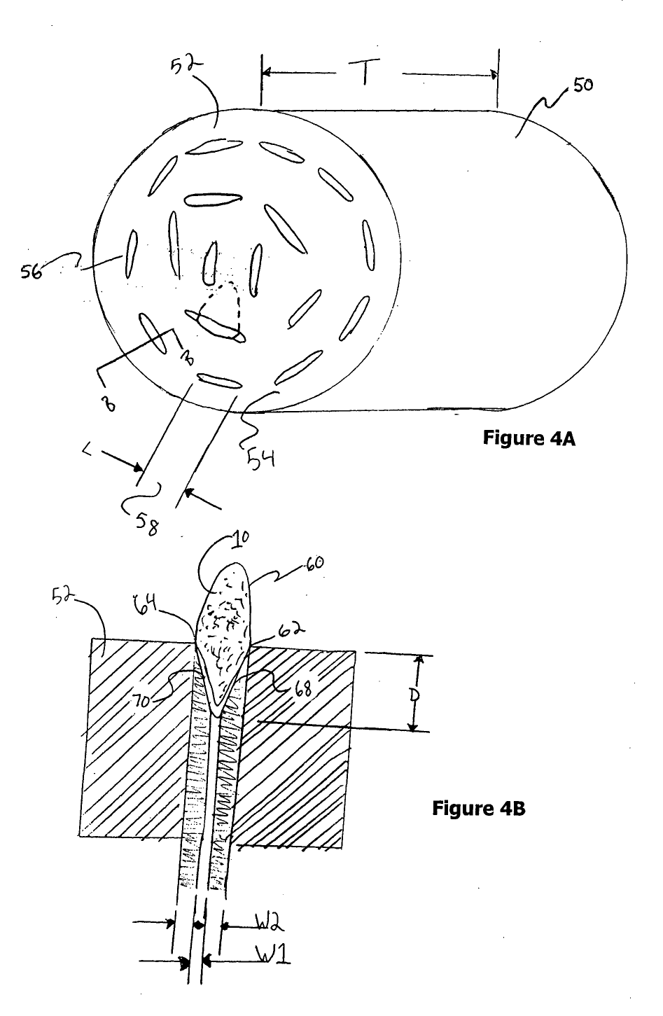

FIG. 4A shows a perspective view of an apparatus of the present invention for use in removing moisture from the surface of the flavored pick 10. The apparatus consists of a housing 50 at least 1 inch high in the preferred embodiment, and constructed in the shape of a cylinder. The device could be a rectangle, triangle, or any other geometric form. Housing 50 is constructed from a sponge-like material 52 and is capable of absorbing moisture. The front surface 54 of housing 50 contains a plurality of slots 56, the length 58 of each slot is sized to accommodate the differing lengths encountered within a variety of different flavored picks 10.

A cross-section B-B of one such slot 56 is illustrated in FIG. 4B. Slot thickness W1 is approximately 0.25 mm, somewhat less than that of a thin flavored pick 10. Slot depth D is approximately 20 mm. The thickness W2 of the top 60 of slot 56, is generally greater than slot thickness W1 so as to form a wedge shape, said thickness W2 approximating the width T of the top of flavored pick 10 depicted in FIG. 1B, which can be inserted into slot 56.

When a player inserts a wet, flavored pick 10 of thickness W2 into slot 56, pick surfaces 62 and 64 force slot sides 68 and 70 apart, exerting a wiping and/or wicking action on the pick surfaces 62 and 64. This wiping and/or wicking action causes moisture to be removed from pick surfaces 62 and 64 and absorbed by the sponge-like material 52. Additionally, the pressure exerted by slot sides 68 and 70 upon pick surfaces 62 and 64 is sufficient to hold securely any pick 10 inserted into slot 56.

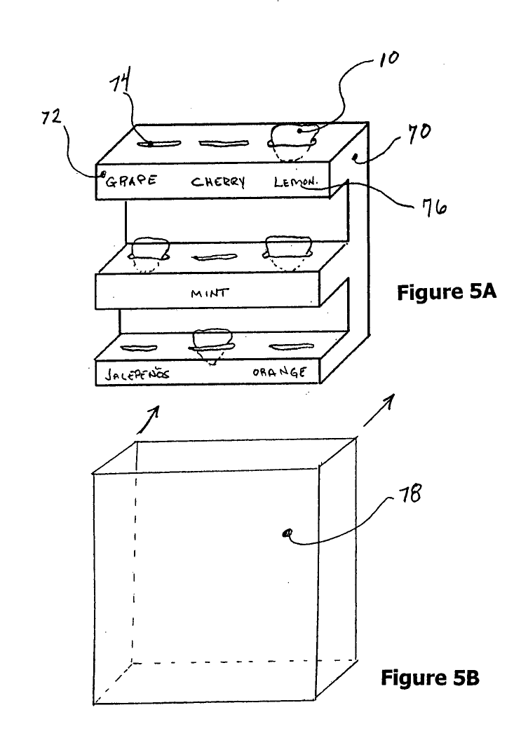

FIG. 5A illustrates an apparatus for storing and displaying flavored picks. A collector of the flavored picks 10 can use the display case 70, to display the collection of picks 10. The case 70 can be made of wood, plastic or metal and can be made to different sizes and configurations to hold any number of picks 10. Slots 74 in the display case are sized to accept and contain different picks 10 of different flavor. Using the display case 70, one can show the collection of picks 10. FIG. 5B illustrates a cover 78 for the display case 70. Once picks 10 are positioned into the display case 70, the cover, which may be made of Lucite, plastic or some other transparent or translucent material, can be placed over the case 70 to allow viewing of the picks 10 without access to them.

While these descriptions directly describe the above embodiments, it is understood that those skilled in the art may conceive of variations in pick size, shape or materials or variations in the methods used to manufacture the flavored pick or the methods described to convert the standard pick into the flavored pick or in the means of mixing or affixing flavoring agents or in the nature of the laminate and its adhesive. Any such modifications or variances that fall within the purview of this description and which produce a flavored pick are intended to be included therein as well. It is understood that the description herein is intended to be illustrative only and is not intended to be limitative. Rather, the scope of the invention described herein is limited only by the claims appended hereto.

1. An apparatus for transmitting flavor to a player of a stringed instrument, comprising:
a pick, said pick having a flavoring agent located within a portion of said pick such that when said pick is placed in the mouth of said player, some or all of said flavoring agent is transmitted from said pick to said player.

2. The apparatus of claim 1 wherein said pick is made up of nylon, plastic, plastic polymer, metal, ceramic, celluloid, copper, stainless steel, aluminum, bone, tortoise shell, wood, frosted glass, gold, silver, platinum, stone, felt, graphite, rubber, or a blend of these materials.

3. The apparatus of claim 1 wherein said portion of said pick is the entire pick.

4. The apparatus of claim 1 wherein said portion of said pick is the surface of the pick.

5. The apparatus of claim 1 wherein said portion of said pick is substantially the surface of the pick.

6. The apparatus of claim 1 wherein said flavoring agent is contained within an external carrier, said carrier being attached to the surface of the pick.

7. An assembly for imparting flavor to the player of a stringed instrument when said assembly is placed in player's mouth comprising:
a standard pick for use with stringed instruments, and
a carrier, said carrier containing a flavoring agent, said carrier being attached to the surface of said standard pick.

8. A method for manufacturing a flavored pick comprising steps of:
a) creating a flavored mixture including a flavoring agent and a molding material;
b) using said mixture in a molding process to manufacture a flavored pick.

9. The method of claim 8 wherein said molding material is a liquid plastic.

10. The method of claim 8 wherein said molding material is a liquid metal.

11. The method of claim 8 wherein said molding material is a liquid rubber.

12. A method for making a flavored pick comprising steps of:
a) selecting a standard pick; and
b) attaching a flavoring agent to said standard pick.

13. The method of claim 12 wherein said attaching further comprises the step of removing excess fluid from said pick leaving a flavored coating.

14. The method of claim 12 wherein said attaching comprises the step of pressing granulates of flavoring agent into said pick.

15. The method of claim 12 wherein said attaching comprises the step of compressing an evaporative form of flavoring agent onto said pick.

16. The method of claim 12 wherein said attaching comprises the step of printing on the surface of said pick using a flavored ink.

17. The method of claim 16 wherein said printing deposits a pattern.

18. The method of claim 17 wherein said pattern is used to gauge how much flavor remains on the pick.

19. The method of claim 17 wherein said pattern is used for identifying said pick.

20. The method of claim 17 wherein said pattern is used for advertising.

21. The method of claim 12 wherein said attaching comprises the step of adhering a flavored laminate to the pick.

22. The method of claim 21 wherein said flavored laminate is an assembly comprising porous material and flavoring agent retained in said porous material, and edible adhesive coating.

23. The method of claim 12 wherein said attaching comprises, the steps of:
a) soaking said pick in a flavoring agent;
b) removing said pick from said flavoring agent; and
c) drying said pick.
